(19) United States
(12) Patent Application Publication
(10) Pub. No.: US 2012/0146413 A1
(43) Pub. Date: Jun. 14, 2012

(54) TERMINAL DEVICE AND CONSUMPTION CURRENT CONTROL METHOD

(75) Inventor: Tomoki Katsumata, Kanagawa (JP)

(73) Assignee: Panasonic Corporation, Osaka (JP)

(21) Appl. No.: 13/391,696

(22) PCT Filed: Aug. 19, 2010
(86) PCT No.: PCT/JP2010/005125

§ 371 Date: Feb. 22, 2012

(30) Foreign Application Priority Data
Aug. 24, 2009 (JP) 2009 193375

(51) Int. Cl. H02J 4/00

(52) U.S. Cl. 307/24

(57) ABSTRACT

Provided are a terminal device and a consumption current control method which enable reliable charging with a current obtained by power generation. In a terminal device (100), a charging display control unit (106) changes the current amount adjustment value set in a constant current control unit (107) on the basis of a current value (the current value of a current (A)) detected by a current detection unit (102) and a current value (the current value of a current (E)) detected by a current detection unit (105). More specifically, when the current value of the current (A) is smaller than the current value of the current (E), the current amount adjustment value is changed. This change makes the current value of the composite current (E) after the change smaller than that before the change. Thus, the current amount adjustment value can be adjusted as soon as a current drawn from a battery (104) becomes larger than a charging current, so that the state in which the current drawn from the battery (104) is smaller than the charging current can be maintained. As a result, charging can be efficiently and reliably performed.

### TECHNICAL FIELD

The present invention relates to a terminal apparatus and a consumption current control method.

### BACKGROUND ART

A portable terminal is used on the premise that a user carries it about. Therefore, the portable terminal is provided with a charging circuit and a battery, for example, as disclosed in Patent Literature 1, and this charging circuit and a charger are connected to each other so that the battery is charged. Thus, the user can utilize the portable terminal even at a place where no power supply is available, by using power charged in the battery.

Moreover, in recent years, there have been proposed portable terminals in which a power generation unit such as a solar battery is installed. A current generated by the power generation unit is charged into the battery, and is also supplied to circuits including a charging display unit, etc. With this structure, it is expected that the portable terminal can be charged and utilized even where no power supply is available.

### Citation List

### Patent Literature

### PTL 1

### Japanese Patent Application Laid-Open No. 2005-86933

### SUMMARY OF INVENTION

### Technical Problem

However, in the case when the power generation unit of a solar battery or the like is simply connected to a charging system of a conventional portable terminal, a problem arises in that its charging process is not carried out with high efficiency. In particular, in the case when a power generation unit having a small generated output such as a solar battery is installed, even if a charging display indicating a charging state is given, almost all generated current is actually consumed by circuits and the like including the charging display unit, or a take-out current from the battery is too high, with the result that there is no progress in its charging process.

The object of the present invention is to provide a terminal apparatus and a consumption current control method capable of reliably charging a generated current.

### Solution to Problem

The terminal apparatus of the present invention is provided with a first detection section that detects a current value of a current generated by a power generation section; a distribution section that distributes the generated current to a battery and a charging state display section; a second detection section that detects the current value of a composite current of the current to be outputted from the battery to the charging state display section and the current distributed to the charging state display section by the distribution section; a current adjustment section that adjusts the composite current based upon a current amount adjusted value; and a control section that alters the current amount adjusted value based upon the current value detected by the first detection section and the current value detected by the second detection section.

The consumption current control method of the present invention is provided with: a first detection step of detecting a current value of a current generated by a power generation section; a distribution step of distributing the generated current to a battery and a charging state display section; a second detection step of detecting the current value of a composite current of the current to be outputted from the battery to the charging state display section and the current distributed to the charging state display section by the distribution step; a control step of altering a current amount adjusted value based upon the current value detected by the first detection step and the current value detected by the second detection step and a current adjustment step of adjusting the composite current based upon the current amount adjusted value.

### Advantageous Effects of invention

The present invention can provide a terminal apparatus and a consumption current control method capable of reliably charging a generated current.

### BRIEF DESCRIPTION OF DRAWINGS

FIG. 1 is a block diagram that illustrates a structure of a terminal apparatus in accordance with one embodiment of the present invention; and

FIG. 2 is a flow chart explaining operations of the terminal apparatus.

### DESCRIPTION OF EMBODIMENTS

Hereinafter, one embodiment of the present invention will be described in detail with reference to the drawings.

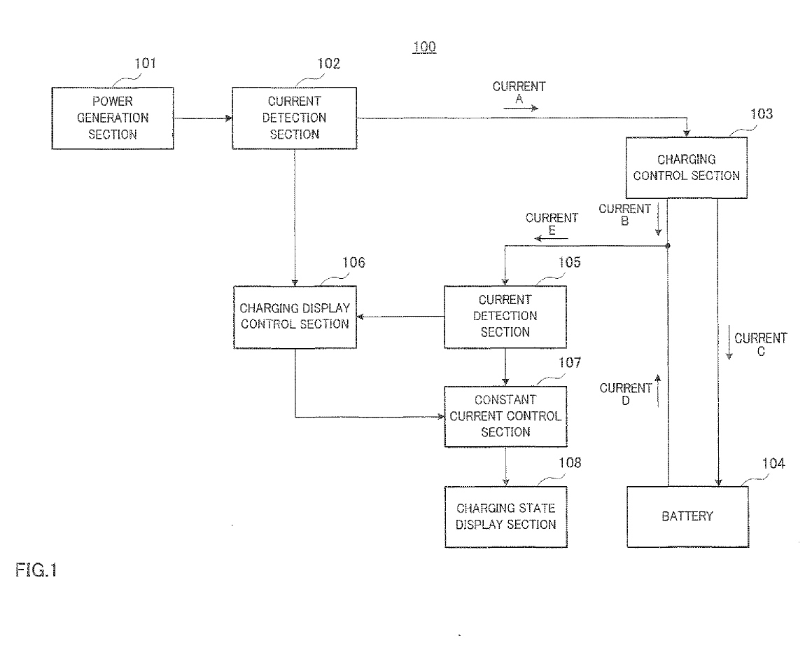

FIG. 1 is a block diagram illustrating terminal apparatus 100 in accordance with one embodiment of the present invention. In FIG. 1, terminal apparatus 100 is provided with power generation section 101, first current detection section 102, charging control section 103, battery 104, second current detection section 105, charging display control section 106, constant current control section 107 and charging state display section 108.

Power generation section 101 outputs a generated power to charging control section 103. Power generation section 101 is a power generation means such as, for example, a solar battery or a fuel battery.

Current detection section 102 is connected to a power supply line between power generation section 101 and charging control section 103. Current detection section 102 detects a current value of a current outputted from power generation section 101. The current value thus detected is outputted to charging display control section 106.

Charging control section 103 outputs a current supplied from power generation section 101 toward battery 104 and charging state display section 108.

Battery 104 is charged with a current received from charging control section 103. Moreover, battery 104 supplies power to charging state display section 108. The amount of a current to be supplied from battery 104 to charging state display section 108 is determined based upon a set value according to a drawing current target value set in constant current control section 107 and the amount of a current outputted from charging control section 103 to charging state display section 108.

Current detection section 105 detects a current value of a composite current formed by combining the current outputted from charging control section 103 to charging state display section 108 and the current to be supplied to charging state display section 108 from battery 104. The current value thus detected is outputted to charging display control section 106.

Charging display control section 106 controls a charge display based upon a current value detected by current detection section 102 and a current value detected by current detection section 105. The control of the charge display is carried out by adjusting a set value preset in constant current control section 107. More specifically, charging display control section 106 first compares the current value detected by current detection section 102 and the current value detected by current detection section 105 with each other. Moreover, in the case when the current value detected by current detection section 105 is greater than the current value detected by current detection section 102, charging display control section 106 adjusts the set value. In this case, charging display control section 106 adjusts the set value in a manner so as to make the drawing current smaller than that at the present point of time.

Constant current control section 107 controls the amount of a current to be outputted to charging state display section 108 based upon the set value determined by charging display control section 106. More specifically, constant current control section 107 draws the amount of a current in accordance with the set value from charging control section 103 and battery 104, and outputs the current to charging state display section 108.

Charging state display section 108 displays a charging state in response to a current supplied from constant current control section 107. Charging state display section 108 is prepared as, for example, LED's, liquid crystal display means, EL display means, etc. In this case, when the current value detected by current detection section 105 is greater than the current value detected by current detection section 102, the amount of a current is controlled to be made smaller by constant current control section 107, with the result that luminance of the charging state display itself is lowered.

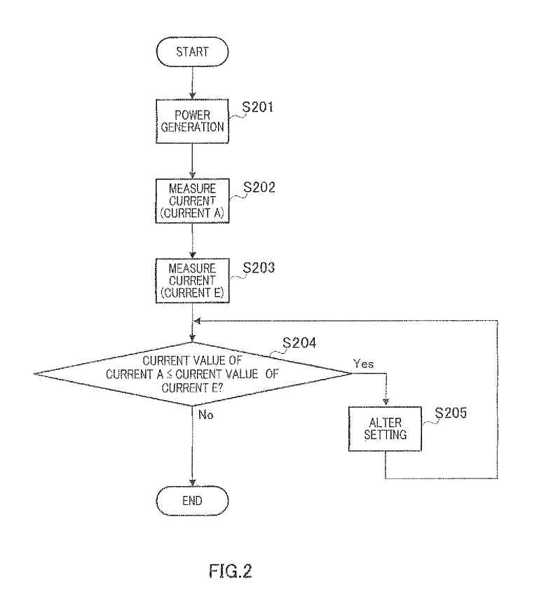

Operations of terminal apparatus 100 having the above-mentioned structure will be described below. FIG. 2 is a flow chart explaining operations of terminal apparatus 100.

In FIG. 2, power generation conditions are satisfied in step S201, power generation is performed in power generation section 101.

In step S202, current detection section 102 detects a current value of an output current (current A) of power generation section 101. This current A is distributed to battery 104 and charging state display section 108 in charging control section 103. In this case, as shown in FIG. 1, a current to be distributed to charging state display section 108 is defined as current B, and a current to be distributed to battery 104 is defined as current C. That is, the following equation is satisfied: current A=current B+current C (first relationship). Then, current C is charged to battery 104. Moreover, a take-out current from battery 104 is defined as current D.

In step S203, current detection section 105 detects a current value of current E formed by combining current B with current D. That is, the following equation is satisfied: current E=current B+current D (second relationship).

In step S204, charging display control section 106 compares the current value of current A with the current value of current E.

In the case when the current value of current A is greater than the current value of current E (NO: in step S204), no alteration is made in the set value of constant current control section 107.

In the case when the current value of current A is the current value of current E or less (YES: in step S204), charging display control section 106 alters the set value of constant current control section 107 in step S205. This alteration is repeatedly carried out until the current value of current A has become greater than the current value of current E.

As described above, charging display control section 106 controls the set value of constant current control section 107 so as to satisfy the relationship of current A>current E (third relationship). When also taken the first and second relationships into consideration, by satisfying the third relationship, a relationship current C>current D is satisfied after all. That is, in the case when the third relationship is satisfied, since a current to be charged becomes greater than a current to be taken out, it is possible to positively carry out a charging process with high efficiency.

In this manner, in accordance with the present embodiment, in terminal apparatus 100, charging display control section 106 changes a current amount adjusted value to be set in constant current control section 107 based upon a current value (current value of current A) detected by current detection section 102 and a current value (current value of current E) detected by current detection section 105. More specifically, when the current value current of current A is smaller than the current value of current E, the current amount adjusted value is altered. By this alteration, the current value of composite current E after the alteration becomes smaller in comparison with that before the alteration.

With this arrangement, when there is a state in which a take-out current from battery 104 becomes greater than a charging current, the current amount adjusted value can be immediately adjusted so that it is possible to maintain a state in which the take-out current from battery 104 is smaller than the charging current. As a result, the charging process can be carried out efficiently and reliably.

Additionally, in the above explanation, by altering the current amount adjusted value, the current value of current E after the alteration is reduced at the same rate; however, the present invention is not limited to this, and, for example, the current amount adjusted value at present and a current amount adjusted value for use in reducing current E may be alternately set. That is, in the case when the current value of current A is smaller than the current value of current E, charging display control section 106 alters the current amount adjusted value so that a first section in which the amount of composite current (current amount of current E) is in a reference level and a second section in which the amount of composite current is lower than the reference level may be formed. When this control process is carried out, flashing is provided in the case of using LED's in the charging state display section. With this arrangement, it is possible to make the average value of the current value of current E smaller within a constant span.

Moreover, the above explanation has been given by exemplifying a structure in which power generation section 101 forms one component of terminal apparatus 100; however, the present invention is not limited to this, and power generation section 101 may be prepared as a separated component from terminal apparatus 100 and may be attached to terminal apparatus 100 as an externally attached component.

The disclosure of Japanese Patent Application No. 2009-193375 filed on Aug. 24, 2009, including the specification, drawings and abstract, is incorporated herein by reference in its entirety.

### INDUSTRIAL APPLICABILITY

The terminal apparatus and consumption current control method of the present invention is effectively utilized as an apparatus capable of reliably charging a generated current.

### Reference Signs List

100 Terminal apparatus
101 Power generation section
102, 105 Current detection section
103 Charging control section

### 104 Battery

106 Charging display control section
107 Constant current control section
108 Charging state display section

1. A terminal apparatus comprising:
a first detection section that detects a current value of a current generated by a power generation section;
a distribution section that distributes the generated current to a battery and a charging state display section;
a second detection section that detects a current value of a composite current of the current to be outputted from the battery to the charging state display section and the current distributed to the charging state display section by the distribution section;
a current adjustment section that adjusts the composite current based upon a current amount adjusted value; and
a control section that alters the current amount adjusted value based upon the current value detected by the first detection section and the current value detected by the second detection section.

2. The terminal apparatus according to claim 1, wherein when the current value detected by the first detection section is smaller than the current value detected by the second detection section, the current amount adjusted value is altered.

3. The terminal apparatus according to claim 2, wherein the control section makes the amount of the composite current smaller by altering the current amount adjusted value.

4. A consumption current control method comprising:
a first detection step of detecting a current value of a current generated by a power generation section;
a distribution step of distributing the generated current to a battery and a charging state display section;
a second detection step of detecting the current value of a composite current of the current to be outputted from the battery to the charging state display section and the current distributed to the charging state display section by the distribution step;
a control step of altering a current amount adjusted value based upon the current value detected by the first detection step and the current value detected by the second detection step; and
a current adjustment step of adjusting the composite current based upon the current amount adjusted value.

5. The consumption current control method according to claim 4, wherein in the control step, when the current value detected by the first detection step is smaller than the current value detected by the second detection step, the current amount adjusted value is altered.

6. The consumption current control method according to claim 5, wherein in the control step, the amount of the composite current is made smaller by altering the current amount adjusted value.
